(19) United States
(12) Patent Application Publication
(10) Pub. No.: US 2006/0143593 A1
(43) Pub. Date: Jun. 29, 2006

(54) Runtime string population in help files

(75) Inventors: John G. Caffrey, Tuam (IE); John B. Murphy, Killiney (IE); Olivier W. van Noort, Almere (NL)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/023,888

(22) Filed: Dec. 27, 2004

(51) Int. Cl. G06F 9/44

(52) U.S. Cl. 717/120

(57) ABSTRACT

The invention populates UI terms referenced in help files of a software program with the corresponding UI terms used in the user interface controls of the software program during execution of the software program. The UI terms referenced in the help files are uniquely identified. A repository is built that contains information identifying the UI terms referenced in the help files and their corresponding UI terms in the user interfaces of the software program. A software component is provided that is capable of runtime population of the UI terms referenced in the help files with their corresponding UI terms in the user interfaces of the software program, using information stored in the repository.

### FIELD OF THE INVENTION

The invention relates to computer software and, more particularly, to user assistance help files for computer software.

### BACKGROUND OF THE INVENTION

Many software programs include user assistance help files for assisting users in the performance of particular program functions. The instructions provided by user assistance (hereinafter “UA”) help files often detail particular steps that need to be executed in order to perform a particular program function. The instructions may include references to specific user interface terms. User interface terms (hereinafter “UI terms”) are words used to describe the user interface controls (i.e., menus, tabs, toolbars, pictures, icons, and other tools) that allow a user to interact with the software program. The instructions in UA help files may reference UI terms (hereinafter “UI references”) to assist a user in understanding which user interface control to use to perform a particular function. For example, the instructions may advise a user to select the “Edit” menu, “Edit” being a UI reference.

In order to avoid user confusion, it is desirable to maintain consistency between the UI terms used in the user interface of a software program and the UI references included in the UA help file of the same software program. However, such consistency may not be available, for example, when the software program's user interface language (hereinafter “UI language”) is different from the language of the program's UA help file (hereinafter “UA language”).

A UI language defines the language in which user interface controls of a software program are displayed to a user. In today's international markets, cost restrictions during software development often result in partial localization of a software program. For example, while the user interface of a software program may be localized to a particular local language, the UA help files may not be localized, remaining in their original language, which is different from the UI language. For instance, Microsoft® Windows® XP offers a language interface pack (hereinafter “LIP”). LIP is an add-on component that is installed on top of an operating system. One function of LIP is to partially localize the user interface of software programs to the user's preferred language. The majority of the UA help files, however, remain completely in the operating system's language, i.e., the base or original language.

Differences between the UI reference and its corresponding UI term can confuse a user of a software program. For example, the UA help files may refer to the UI term “Edit” as “Edit” (if the UA language is English) while the software program user interface may display the term as “xxx” (if the UI language is a language other than English). Even if a user is familiar with the UA language, the fundamental language inconsistency between the UI references in the UA help files and the UI terms in the user interfaces of the software program renders the content in the UA help files confusing and often unusable.

In addition, even if the UI language and the UA language of a software program are the same, inconsistencies may still exist between UI references and their corresponding UI terms in a software program. For example, in order to develop a software program in a timely fashion, the UA content development process of the software program may be started before or concurrently with the user interface development process. In such a case, the UI references in the UA help files are included as ordinary text, with reference to the software program in its pre-released state. Any subsequent changes to UI terms in the software program during the development process of the software program will result in differences between the UI references and their corresponding UI terms. There can be other differences existing between a UI reference and its corresponding UI term.

While differences between a UI reference and the corresponding UI term can be removed, for example, by manually replacing the UI references in the UA files with the corresponding UI terms, this approach is undesirable: Manual replacement can be time consuming and expensive.

Therefore, there exists a need for a method and system that automatically populates UI references in a UA file of a software program with the corresponding UI terms in the user interfaces of the software program.

### SUMMARY OF THE INVENTION

The invention addresses the above-identified need by enabling runtime population of UI references in the UA help files of a software program with the corresponding UI terms in the user interface controls of the software program, when the UI references and the UI terms are different. In this regard, UI references in UA help files of a software program are uniquely identified, for example, by tagging each UI reference with a unique ID.

Preferably a repository that stores information concerning the tagged UI references and their corresponding UI terms is built. In one form, equivalent instances of a tagged UI reference are first identified. The equivalent instances include all instances of matching source strings of the UI reference. Equivalent instances are preferably stored in software resource files, which include user interface resource files containing UI terms for the user interfaces of the software program. Next, a direct match for the UI reference is located among the equivalent instances. For example, the direct match should have the same classification, such as resource category, as the UI reference. Finally, data concerning the UI reference and its direct match is written into a repository. Preferably the data identifies the UI reference, its direct match, and the software resource file that stores the direct match.

Preferably, a software component that is capable of runtime population of a tagged UI reference with its direct match is also provided. In one form, each UA help file containing at least one tagged UI reference has a link to the software component. Execution of the software program initializes the software component. The software component first obtains information on the current UI language. The software component then extracts a tagged UI reference from a UA help file and queries the repository to identify the software resource file containing the direct match of the UI reference. The software component uses information on the current UI language to locate the correct version of the software resource file containing the direct match of the UI reference. Conventionally, a computing system with a multilingual UI environment could have multiple versions of the same software resource file in different languages and store the multiple versions in different locations. The software component then retrieves the direct match from the corresponding software resource file. Finally, the software component populates the tagged UI reference in the UA help file with the direct match in the software resource file.

In summary, the invention enables runtime population of UI references in UA help files with the corresponding UI terms in the user interfaces of the software program. As a result, the invention maintains consistency between the UI terms as they appear in the software program and as they appear in the UA help files.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A is a pictorial diagram illustrating a UA help file prior to runtime string population;

FIG. 1B is a pictorial diagram illustrating the same UA help file shown in FIG. 1A that has its UI references populated with the corresponding UI terms during the execution of the software program;

FIG. 2 is a block diagram illustrating an exemplary computing environment in which the invention operates;

FIG. 3 is a block diagram illustrating exemplary file objects involved during the production-processing phase of the invention;

FIG. 4 is a flow diagram illustrating an exemplary implementation of the production-processing phase of the invention, i.e., a process for tagging UA help files and building a repository;

FIG. 5 is a flow diagram illustrating an exemplary routine for mapping a tagged UI reference in a UA help file with its corresponding UI term in the user interface of the software program, suitable for use in FIG. 4;

FIG. 6 is a block diagram illustrating exemplary file objects involved during runtime string population in a UA help file;

FIG. 7 is a flow diagram illustrating an exemplary process for runtime string population in a UA help file; and

FIG. 8 is a flow diagram illustrating an exemplary routine for populating a tagged UI reference in a UA help file with the corresponding UI term, suitable for use in FIG. 7.

### DETAILED DESCRIPTION OF THE PREFERRED EMBODIMENT

The invention enables runtime population of UI references in UA help files of a software program with corresponding UI terms in the user interface controls of the software program. One aspect of the invention attaches a unique tag to each UI reference in a UA help file. The invention also creates a repository containing data identifying each UI reference and the whereabouts of its corresponding UI term in the software resource files. Another aspect of the invention provides a software component that can populate each tagged UI reference with its corresponding UI term during execution of the software program, using information provided by the repository. As a result, a tagged UI reference in a UA help file is automatically populated by the actual UI term that the software program is using. This population thus creates absolute consistency between the UI references in the software program's UA help files and the UI terms in the user interfaces of the software program.

Exemplary embodiments of the invention are described in the general context that the UA language of a software program is different from the current UI language of the software program. Such a difference induces a need to populate UI references with their corresponding UI terms in order to keep UI references in the UA help files consistent with the UI terms in the user interfaces of the software program. However, those skilled in the art and other related fields will appreciate that the invention is applicable to all software programs whose UI references are inconsistent with the UI terms in the user interfaces of the software program.

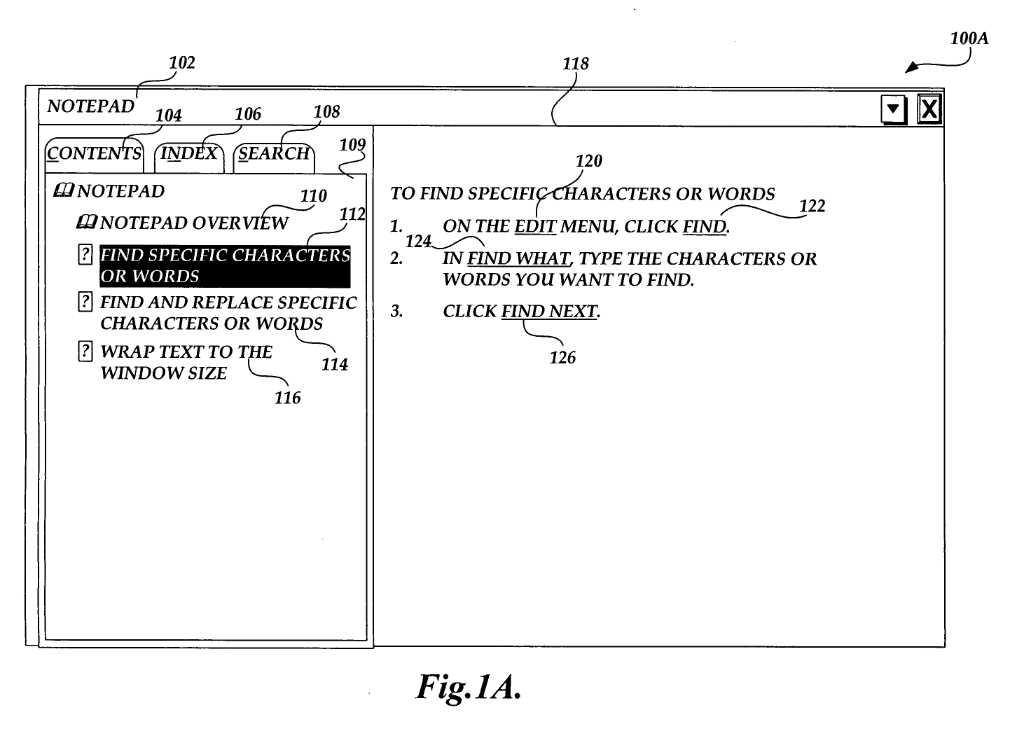

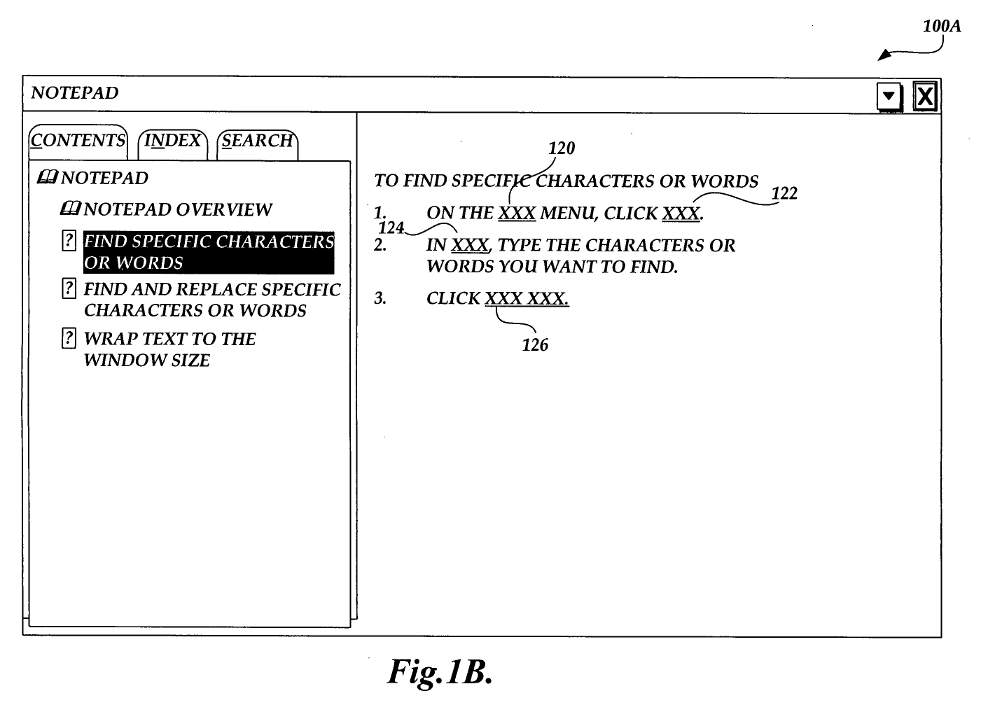

FIGS. 1A-1B illustrate one exemplary software program whose UI references are inconsistent with its UI terms and are therefore populated with the UI terms during execution of the software program. Specifically, FIG. 1A illustrates an exemplary page of a UA help file 100A in the software program Notepad 102, wherein the UA help file 100A is in English but the user interface (not shown) of the software program Notepad 102 is at least partially localized to a human language that is not English. As shown in FIG. 1A, the UA help file 100A contains tabs such as Contents 104, Index 106, and Search 108. When the Contents tab 104 is actuated, the UA help file 100A displays a content table 109, which outlines the help contents for the software program. For example, The “Notepad Overview” chapter 110 contains topics such as “Find Specific Characters or Words” 112, “Find and Replace Specific Characters or Words” 114, and “Wrap Text to the Window Size” 116.

As shown in FIG. 1A, once a user selects the “Find Specific Characters or Words” 112 topic, the UA help file 100A displays the detailed content for the topic 112 in a content panel 118. In the detailed content, as shown in the content panel 118, the UA help file 100A contains specific UI references, such as EDIT 120, FIND 122, FIND WHAT 124, FIND NEXT 126. These UI references are usually distinguished from the rest of the help content in some manner. For example, as shown in FIG. 1A, the UI references EDIT 120, FIND 122, FIND WHAT 124, and FIND NEXT 126 are underlined while the rest of the help content is not.

FIG. 1B illustrates the UA help file 100A whose UI references are replaced by the corresponding UI terms, the UI terms being in a language that is different from the UA language, i.e., English. As shown in FIG. 1B, in this version of the UA help file 100A, the UI references are changed into the UI language that the software program Notepad 102 is using. For illustration purposes, FIG. 1B represents the translated UI references 120, 122, 124, and 126 with the letters “XXX”. The “XXX” representation is to indicate that the UI language used by the software program Notepad 102 can be any language other than the UA language, i.e., English, of the UA help file 100A.

The following description will first provide an exemplary operating environment for the invention. Then a process will be described for building components that enable a one-to-one match between a UI reference in UA help file and the corresponding UI term in the user interfaces of the software program. Finally, a detailed description is provided for a process that substitutes a UI reference in a UA help file with the corresponding UI term in the software resource files during the execution of the software program. The illustrative examples provided herein are not intended to be exhaustive or to limit the invention to the precise forms disclosed. Similarly, any steps described herein may be interchangeable with other steps, or combinations of steps, in order to achieve the same result.

Exemplary Operating Environment

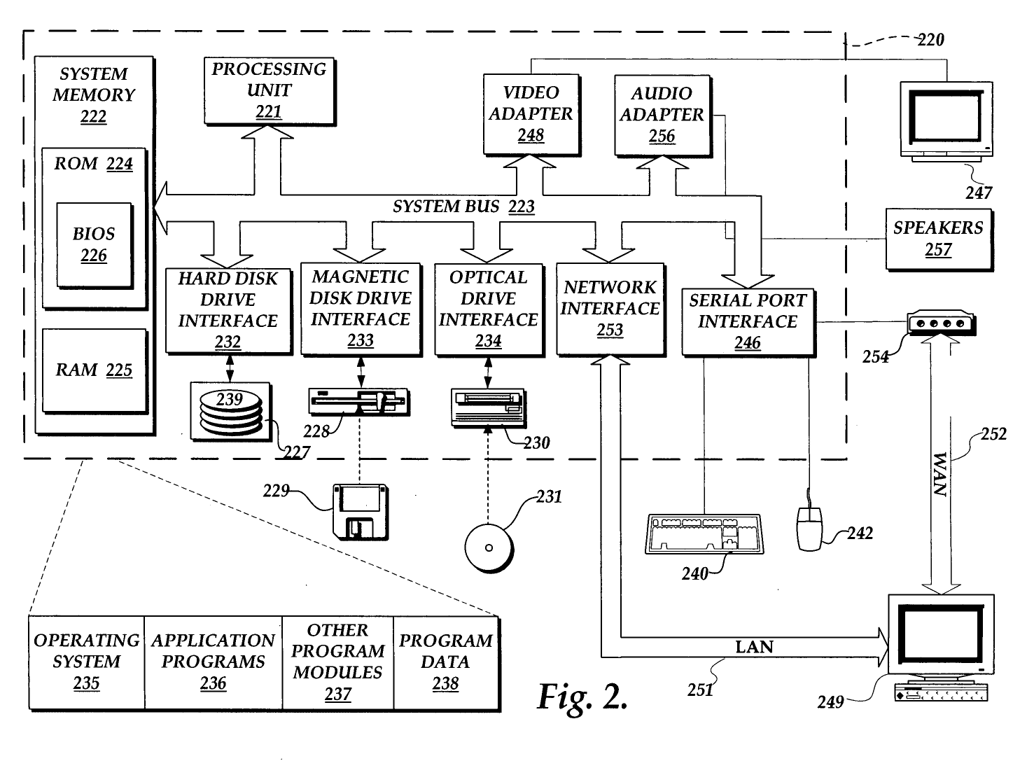

FIG. 2 and the following discussion are intended to provide a brief and general description of a suitable computing environment in which the invention may be implemented.

Although not required, the invention will be described in the context of computer-executable instructions, such as program modules, being executed by a personal computer. Generally, program modules include routines, programs, objects, components, data structures, etc. that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

It should be further understood that the present invention may also be applied in the context of users accessing content on the Internet via a browser; so the present invention may apply to much lower end devices that may not have many of the components described in reference to FIG. 2 (e.g., hard disks, etc.).

With reference to FIG. 2, an exemplary system for implementing the invention includes a general purpose-computing device in the form of a conventional personal computer 220. The personal computer 220 includes a processing unit 221, a system memory 222, and a system bus 223 that couples various system components including the system memory to the processing unit 221. The system bus 223 may be any of several types of bus structures, including a memory bus or memory controller, a peripheral bus, and a local bus using any of a variety of bus architectures. The system memory includes read only memory (ROM) 224 and random access memory (RAM) 225. A basic input/output system 226 (BIOS), containing the basic routines that help to transfer information between elements within the personal computer 220, such as during start-up, is stored in ROM 224.

The personal computer 220 further includes a hard disk drive 227 for reading from and writing to a hard disk 239, a magnetic disk drive 228 for reading from or writing to a removable magnetic disk 229, and an optical disk drive 230 for reading from or writing to a removable optical disk 231 such as a CD-ROM or other optical media. The hard disk drive 227, magnetic disk drive 228, and optical disk drive 230 are connected to the system bus 223 by a hard disk drive interface 232, a magnetic disk drive interface 233, and an optical drive interface 234, respectively. The drives and their associated computer-readable media provide nonvolatile storage of computer-readable instructions, data structures, program modules, and other data for the personal computer 220.

Although the exemplary environment described herein employs a hard disk 239, a removable magnetic disk 229, and a removable optical disk 231, it should be appreciated by those skilled in the art that other types of computer-readable media that can store data that is accessible by a computer, such as magnetic cassettes, flash memory cards, digital video disks, Bernoulli cartridges, random access memories (RAMs), read only memories (ROMs), and the like, may also be used in the exemplary operating environment.

A number of program modules may be stored on the hard disk 239, magnetic disk 229, optical disk 231, ROM 224, or RAM 225, including an operating system 235, one or more application programs 236, other program modules 237, and program data 238. For example, the application programs 236 may comprise the Notepad 102 software program illustrated in FIGS. 1A-1B.

A user may enter commands and information into the personal computer 220 through input devices such as a keyboard 240 and pointing device 242. Other input devices (not shown) may include a microphone, joystick, game pad, satellite dish, scanner, or the like. These and other input devices are often connected to the processing unit 221 through a serial port interface 246 that is coupled to the system bus, but may be connected by other interfaces, such as a parallel port, game port, or a universal serial port (USB). A monitor 247 or other type of display device is also connected to the system bus 223 via an interface, such as a video adapter 248. In addition to the monitor, personal computers typically include other peripheral output devices (not shown), such as speakers and printers.

The personal computer 220 may operate in a networked environment using logical connections to one or more remote computers, such as a remote computer 249. The remote computer 249 may be another personal computer, a server, a router, a network PC, a peer device or other common network node, and typically includes many or all of the elements described above relative to the personal computer 220, although only a memory storage device has been illustrated in FIG. 2. The logical connections depicted in FIG. 2 include a local area network (LAN) 251 and a wide area network (WAN) 252. Such networking environments are commonplace in offices, enterprise-wide computer networks, Intranets, and the Internet.

When used in a LAN networking environment, the personal computer 220 is connected to the local network 251 through a network interface or adapter 253. When used in a WAN networking environment, the personal computer 220 typically includes a modem 254 or other means for establishing communications over the wide area network 252, such as the Internet. The modem 254, which may be internal or external, is connected to the system bus 223 via the serial port interface 246. In a networked environment, program modules depicted relative to the personal computer 220, or portions thereof, may be stored in the remote memory storage device. It will be appreciated that the network connections shown are exemplary and other means of establishing a communications link between the computers may be used.

Tagging Help Files and Building a Repository

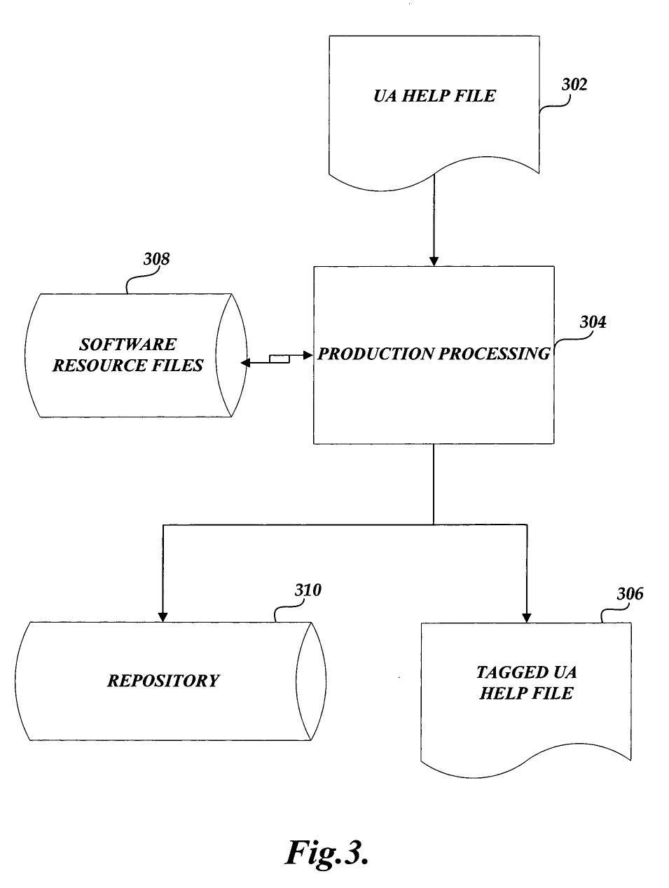

FIGS. 3, 4 and 5 illustrate how UI references in UA help files of a software program are identified and a repository containing matches between the UI references and their corresponding UI terms is built. This process is also called production processing, because it must be performed prior to installing the software program on a computer.

A software program may include one or more UA help files. In an exemplary embodiment of the invention, UA help files are stored as hypertext markup language (HTML) files. Alternatively, UA help files may also be stored in any other suitable file format.

FIG. 3 is a block diagram illustrating exemplary file objects that the production-processing phase of the invention works with or produces. The production-processing phase 304 assigns unique text to the UI references in the UA help file 302 and inserts this text into the UA help file 302 to produce a tagged UA help file 306.

The production-processing phase 304 also works with resource files 308 of the software program to locate matched UI terms of the tagged UI references in the UA help file 302. The software resource files 308 include, among other software resources, UI terms that are used in the user interfaces of the software program. The UI terms may be in a UI language that is different from the UA language of the UA help file 302. The production-processing phase 304 then compiles data concerning the tagged UI references and their matched UI terms into a repository 310. The repository 310 is used as a reference library at run time to populate tagged UI references in the tagged UA help file 306 with their matching UI terms in the software resource files 308.

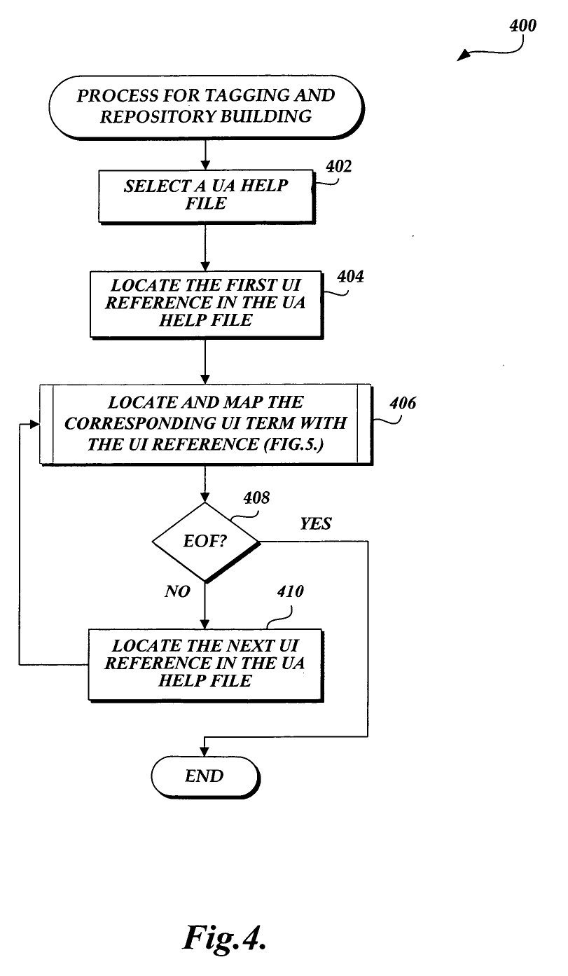

FIG. 4 illustrates one exemplary process 400 that details the operations in the production-processing phrase 304. In essence, the process 400 assigns a unique ID to each UI reference in a UA help file. The process 400 then locates the corresponding UI term by finding a direct match for the UI reference among its equivalent instances in the software resource files. The process 400 also builds a repository storing data pertaining to each UI reference and its corresponding UI term.

Specifically, the process 400 first selects a UA help file such as the UA help file 302 illustrated in FIG. 3. See block 402. The process 400 then parses through the text of the UA help file and locates the first UI reference. See block 404. In an exemplary embodiment of the invention, UI references are easily identifiable because each of them is associated with a distinct format or attribute. For example, each UI reference may be bold-faced or underlined while the rest of the text in the UA help file is not. For instance, an HTML-based UA help file may contain a line of text like this—<h1>on the<b>Edit</b>menu</h1>—which will be displayed as “on the Edit menu,” wherein “Edit” is an UI reference.

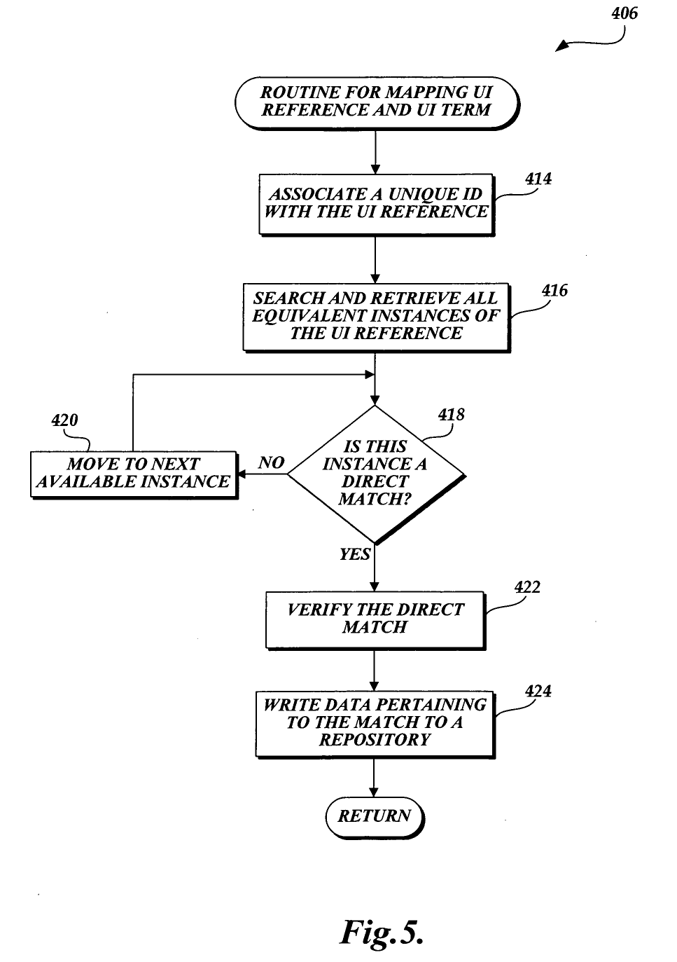

For each identified UI reference, the process 400 executes a routine 406 that maps a corresponding UI term in the user interface of the software program with the UI reference. FIG. 5 is a flow chart illustrating one exemplary routine 406 and will be discussed in more detail later. After executing the routine 406, the process 400 checks to see if it has reached the end of the UA help file it is processing. See decision block 408. If the answer is NO, the process 400 locates the next UI reference in the UA help file. See block 410. The process 400 then executes the routine 406 on the new UI reference. If the answer to decision block 408 is YES, meaning that the process 400 has processed all UI references in the UA help file, the process 400 exits. Typically, a software program contains more than one UA help file. Thus, the process 400 may be executed on each UA help file in a software program.

As noted above, FIG. 5 illustrates one exemplary routine 406 that locates the corresponding UI term for a UI reference and maps the UI term with the UI reference. The routine 406 first associates a unique ID with the UI reference by, for example, assigning the ID to the UI reference and inserting the ID into the UA help file. See block 414.

In an alternative embodiment of the invention, a developer of a software program establishes a unique tag for each UI term in the software program. An author of UA help files of the software program then applies the unique tag to places in the UA help files that reference the UI term. In such an embodiment, the UI reference thus is a placeholder containing a unique tag identifying the corresponding UI term.

The routine 406 then proceeds to search the software resource files to retrieve all equivalent instances of the tagged UI reference including their pseudo-localized equivalents. See block 416. Equivalent instances of a UI reference include all instances of matching source strings, including their pseudo-localized equivalents. Equivalent instances usually are stored in the software resource files. As those skilled in the art and other related fields will appreciate, pseudo-localization of software program is a technique for validating whether the software program is prepared for internationalization. Pseudo-localization allows a software program to be run and tested with strings that are definitely not English but still readable by English readers. That is, wh\acute{ee}ñ pse\ddot{uu}d\acute{oo}Lo [symbol] \hat{aa}l\acute{ii}zed, a striñg be [symbol] omes defińitely ñot \acute{EE}ñglish but is still highly readable. For more information about pseudo-localization, please see Developing International Software, by Dr. International, Second Edition (Microsoft Press, 2003).

After locating all available equivalent instances of the UI reference, the routine 406 proceeds to determine if any of the equivalent instances is a direct match for the UI reference. See block 418. In an exemplary embodiment of the invention, whether an equivalent instance is a direct match of a UI reference can be determined logically by comparing the subject and the category of the equivalent instance and of the UI reference. For example, the exemplary “Edit” UI reference is of the menu category. Thus, an equivalent instance of the “Edit” UI reference is a direct match only if the equivalent instance also is of the menu category.

If the answer to decision block 418 is NO, meaning that this particular equivalent instance is not a direct match for the UI reference, the routine 406 disregards this equivalent instance and moves to process the next available equivalent instance. See block 420. In some embodiments of the invention, if it is difficult to decide whether an equivalent instance is a direct match for a UI reference, a user may manually compare the two terms.

If the answer to the decision block 418 is YES, meaning this equivalent instance is a direct match for the UI reference, the routine 406 verifies the direct match. See block 422. To verify the direct match, an exemplary embodiment of the invention reloads this equivalent instance from its software resource file and confirms that this equivalent instance definitely is a direct match for the UI reference. The verification may find that this equivalent instance is not a direct match for the UI reference. In this case, the routine 406 disregards this equivalent instance and moves to process the next equivalent instance for the UI reference. If the verification confirms that this equivalent instance is a direct match for the UI reference, the routine 406 writes data pertaining to the match into a repository such as the repository 310 illustrated in FIG. 3. See block 424. The data may include the unique ID for the UI reference, the software resource file containing the direct match, the resource type of the direct match, and the resource ID of the direct match, etc. The routine 406 then returns.

Runtime Population of UI References

An exemplary embodiment of the invention uses an active template library (ATL) component to populate UI references in a UA help file of a software program with their corresponding UI terms during execution of the software program. A reference to the ATL component is embedded in each of the UA help files that contain at least one UI reference. During execution of the software program, the ATL component identifies the current UI language of the software program. It also queries the repository, such as the repository 310 illustrated in FIG. 3, to identify the software resource file containing the corresponding UI term for a UI reference. The ATL component then uses information on the current UI language to locate the correct version of the software resource file, if the computing system supports multiple UI languages. Conventionally, a computing system with a multilingual UI environment could have multiple versions of the same software resource file in different languages and store them in different locations. The ATL component then loads the appropriate software resource file containing the UI term and populates the UI reference with the UI term.

The software component first obtains information on the current UI language. The software component then extracts a tagged UI reference from a UA help file and queries the repository to identify the software resource file containing the direct match of the UI reference. The software component uses information on the current UI language to locate the correct version of the software resource file containing the direct match of the UI reference. Conventionally, a computing system with a multilingual UI environment the system could have multiple versions of the same software resource file in different languages and store them in different locations. The software component then retrieves the direct match from the corresponding software resource file. Finally, the software component populates the tagged UI reference in the UA help file with the direct match in the software resource file.

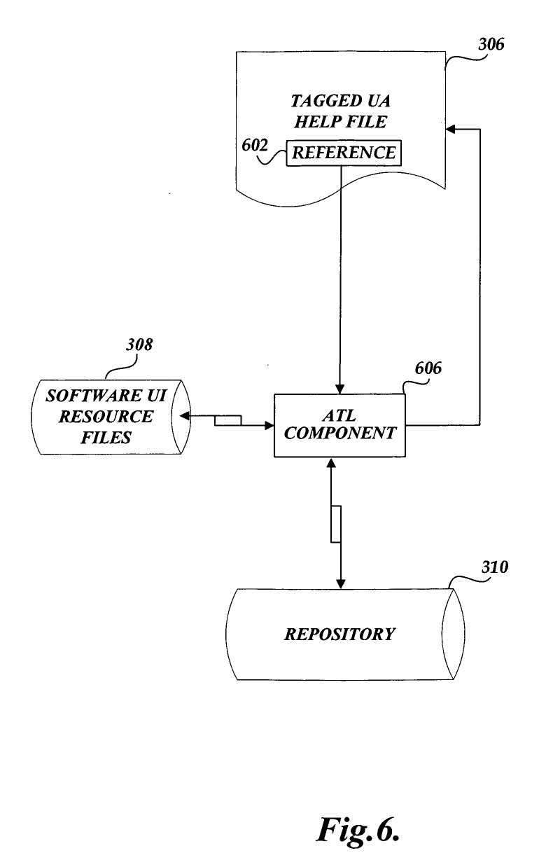

FIG. 6 is a block diagram illustrating the interaction between different file objects during the runtime population of UI references in a UA help file with their corresponding UI terms in the software resource files. In an exemplary embodiment of the invention, an ATL component 606 is registered on the local machine where the software program is installed. A reference 602 to the ATL component 606 is embedded in each tagged UA help file such as the tagged UA help file 306 illustrated in FIG. 3. For example, in HTML-based UA help files, the reference 602 may be embedded using the <embed> and </embed> tags. During execution of the software program, loading of the tagged UA help file 306 initiates the ATL component 606. The ATL component 606 identifies all UI references in the UA help file 306, queries the repository 310 for direct matches, locates the corresponding software resource files 308. The ATL component 606 eventually populates the UI references in the tagged UA help file 306 with the appropriate UI terms.

In an exemplary embodiment of the invention, a user can choose to enable or disable the runtime string substitution functionality provided by the invention via a right-click context menu associated with the software program.

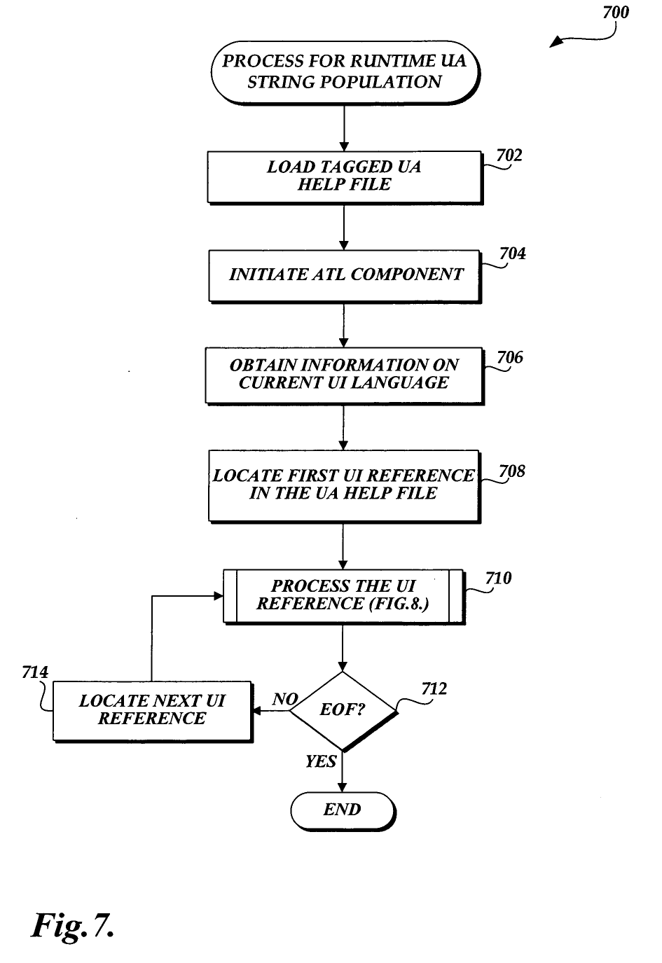

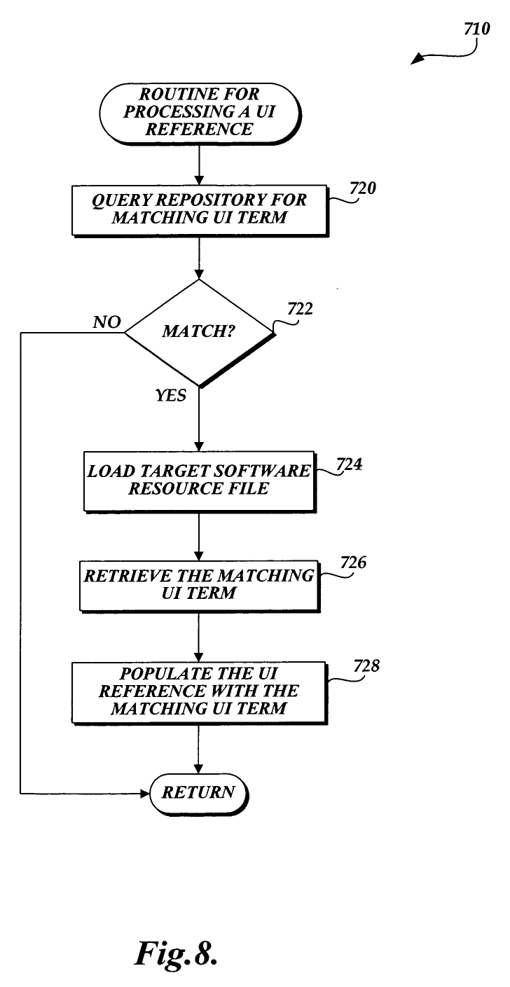

FIG. 7 illustrates one exemplary implementation of a process 700 that populates UI references with their corresponding UI terms. The process 700 first loads a tagged UA help file, which may contain a specific help topic that a user selects. See block 702. The process 700 then initiates the ATL component that is referenced by the UA help file. See block 704. The ATL component queries the local system to obtain information on the current UI language. See block 706. For example, the ATL component may use the GetUserDefaultUILanguage Windows32 API call in Microsoft® Windows® XP to identify the current UI language. The process 700 then reads through the tagged UA help file and locates the first tagged UI reference. See block 708. The process 700 then executes a routine 710 that processes the UI reference and may substitute it with its corresponding UI term. See block 710. FIG. 8 provides an exemplary routine 710 and is described in detail below.

After executing the routine 710, the process 700 checks to see if it has reached the end of the tagged UA help file. See decision block 712. If the answer is NO, the process 700 locates the next UI reference in the tagged UA help file. See block 714. The process 700 then executes the routine 710 on the next UI reference. If the answer to decision block 712 is YES, meaning that the process 700 has reached the end of the tagged UA help file, the process 700 exits.

As noted above, FIG. 8 is a flow diagram illustrating an exemplary routine 710 that populates a UI reference with its corresponding UI term during execution of the software program. The routine 710 first queries a repository, such as the repository 310 illustrated in FIG. 3, to determine whether there is a matching UI term for the UI reference. See block 720. The routine 710 then checks to see if a matching UI term is found. See decision block 722. If the answer is NO, the routine 710 returns. If a matching UI term is found in the repository, the routine 710 loads the software resource file containing the matching UI term. See block 724. In an exemplary embodiment of the invention, the repository 310 contains information that identifies the software resource file storing the matching UI term. The routine 710 then retrieves the matching UI term from the loaded software resource file. See block 726. Finally, the routine 710 populates the UI reference in the tagged UA help file with the matching UI term. See block 728. The routine 710 then exits.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A computer-implemented method for enabling runtime population of software user interface term references (“UI references”) in a help file of a software program with corresponding strings in a user interface (“UI terms”) of the software program, comprising:
identifying a UI reference to be populated in a help file;
locating the corresponding UI term (“direct match”) in the user interface resources of the software program;
writing information concerning the UI reference and the direct match into a repository; and
inserting in the help file a reference to a software component that is capable of populating the UI reference in the help file with the direct match, according to information in the repository, when the software program is executed.

2. The computer-implemented method of claim 1, wherein identifying a UI reference to be populated in a help file includes assigning a unique ID to the UI reference.

3. The computer-implemented method of claim 1, wherein locating the corresponding UI term (“direct match”) in the user interface of the software program includes:
locating in resource files of the software program all equivalent instances for the string; and
finding the direct match among the equivalent instances.

4. The computer-implemented method of claim 1, further comprising:
loading the help file upon receiving a request for the help file during execution of the software program; and
executing the software component referenced in the help file.

5. The computer-implemented method of claim 4, wherein the software component referenced in the help file, when executed:
identifies current user interface language;
locates the UI reference in the help file;
locates the direct match in the current user interface language using information in the repository; and
populates the UI reference in the help file with the direct match if the direct match is found.

6. A computer-readable medium containing computer-executable instructions for enabling runtime population of software user interface references (“UI references”) in a help file of a software program with corresponding strings in a user interface (“UI terms”) of the software program; the computer-executable instructions, when executed:
identify a UI reference to be populated in a help file;
locate the corresponding UI term (“direct match”) in the user interface of the software program;
write information concerning the UI reference and the direct match into a repository; and
insert in the help file a reference to a software component that is capable of populating the UI reference with the direct match, according to information in the repository, when the software program is executed.

7. The computer-readable medium of claim 6, wherein identification of a UI reference to be populated in a help file includes assigning a unique ID to the UI reference.

8. The computer-readable medium of claim 6, wherein the computer-executable instructions, when executed, locate the corresponding UI term (“direct match”) in the user interface of the software program by:
locating in resource files of the software program all equivalent instances for the string; and
finding the direct match among the equivalent instances.

9. The computer-readable medium of claim 6, wherein the computer-executable instructions, when executed, further:
load the help file upon receiving a request for the help file during execution of the software program; and
execute the software component referenced in the help file.

10. The computer-readable medium of claim 9, wherein the software component referenced in the help file, when executed:
identifies current user interface language;
locates the UI reference in the help file;
locates the direct match in the current user interface language using information in the repository; and
populates the UI reference in the help file with the direct match if the direct match is found.

11. A computing system for enabling runtime population of software user interface references (“UI references”) in a help file of a software program with corresponding strings in a user interface (“UI terms”) of the software program, comprising:
(a) a memory; and
(b) a processor, coupled with the memory, for
(i) identifying a UI reference to be populated in a help file;
(ii) locating the corresponding UI term (“direct match”) in the user interface resources of the software program;
(iii) writing information concerning the UI reference and the direct match into the memory; and
(iv) inserting in the help file a reference to a software component that is capable of populating the UI reference with the direct match, according to the information in the memory, when the software program is executed.

12. The computing system of claim 11, wherein identifying a UI reference to be populated in a help file includes assigning a unique ID to the UI reference.

13. The computing system of claim 11, wherein locating the corresponding UI term (“direct match”) in the user interface of the software program includes:
locating in resource files of the software program all equivalent instances for the string; and
finding the direct match among the equivalent instances.

14. The computing system of claim 11, wherein the processor also:
loads the help file upon receiving a request for the help file during execution of the software program; and
executes the software component referenced in the help file.

15. The computing system of claim 14, wherein the software component referenced in the help file:
identifies current user interface language;
locates the UI reference in the help file;
locates the direct match in the current user interface language using information in the repository; and
populates the UI reference in the help file with the direct match if the direct match is found.
